(19) United States
(12) Patent Application Publication
(10) Pub. No.: US 2022/0327718 A1
(43) Pub. Date: Oct. 13, 2022

(54) TECHNIQUES FOR ENHANCING SLOW MOTION RECORDING

(71) Applicant: QUALCOMM Incorporated, San Diego, CA (US)

(72) Inventors: Shubhobrata Dutta Choudhury, New Delhi (IN); Sai Krishna Bodapati, Vijaywada (IN)

(21) Appl. No.: 17/229,383

(22) Filed: Apr. 13, 2021

(51) Int. Cl. G06T 7/254; G06T 7/90

(52) U.S. Cl. CPC G06T 7/254; G06T 7/90; G06T 2207/20132; G06T 2207/10016; G06T 2207/20224

(57) ABSTRACT

Methods, systems, and devices for enhancing scene statistics for slow motion recording are described. The method may include capturing from a first sensor of the device a first set of video frames at a first frame rate, capturing from a second sensor of the device a second set of video frames at a second frame rate different from the first frame rate, analyzing an aspect of the first set of video frames in relation to an aspect of the second set of video frames, generating a mapped set of video frames based on the analyzing and a mapping of the aspect of the first set of video frames to the aspect of the second set of video frames, and storing the mapped set of video frames on a display of the device.

### BACKGROUND

The following relates to image processing, including enhancing scene statistics for slow motion recording.

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

Some image capturing systems capture frames for slow motion video. However, as the frame rate of a slow motion video capturing system increases the exposure time per captured image decreases, and as the exposure time decreases the image quality decreases.

### SUMMARY

The described techniques relate to improved methods, systems, devices, and apparatuses that support increasing the quality of slow motion video. Generally, the described techniques provide for decreasing noise and increasing brightness and lighting detail in slow motion videos. In some cases, the present techniques may include a device configured to capture a first set of video frames using a first camera of the device and simultaneously capture a second set of video frames using a second camera of the device. In some cases, the device may capture the two sets of video frames at different frame rates. In some cases, the device may analyze the two sets of video frames and map the aspects of a frame of the first set of video frames to a frame of the second set of video frames. In some cases, the device may generate an enhanced set of video frames based on combining, in accordance with the mapping, an aspect of the frame of the first set of video frames with an aspect of the frame of the second set of video frames.

A method for image processing at a device is described. The method may include capturing from a first sensor of the device a first set of video frames at a first frame rate, capturing from a second sensor of the device a second set of video frames at a second frame rate different from the first frame rate, analyzing an aspect of the first set of video frames in relation to an aspect of the second set of video frames, generating a mapped set of video frames based on the analyzing and a mapping of the aspect of the first set of video frames to the aspect of the second set of video frames, and storing the mapped set of video frames on a display of the device.

An apparatus for image processing at a device is described. The apparatus may include a processor, memory coupled with the processor, and instructions stored in the memory. The instructions may be executable by the processor to cause the apparatus to capture from a first sensor of the device a first set of video frames at a first frame rate, capture from a second sensor of the device a second set of video frames at a second frame rate different from the first frame rate, analyze an aspect of the first set of video frames in relation to an aspect of the second set of video frames, generate a mapped set of video frames based on the analyzing and a mapping of the aspect of the first set of video frames to the aspect of the second set of video frames, and store the mapped set of video frames on a display of the device.

Another apparatus for image processing at a device is described. The apparatus may include means for capturing from a first sensor of the device a first set of video frames at a first frame rate, means for capturing from a second sensor of the device a second set of video frames at a second frame rate different from the first frame rate, means for analyzing an aspect of the first set of video frames in relation to an aspect of the second set of video frames, means for generating a mapped set of video frames based on the analyzing and a mapping of the aspect of the first set of video frames to the aspect of the second set of video frames, and means for storing the mapped set of video frames on a display of the device.

A non-transitory computer-readable medium storing code for image processing at a device is described. The code may include instructions executable by a processor to capture from a first sensor of the device a first set of video frames at a first frame rate, capture from a second sensor of the device a second set of video frames at a second frame rate different from the first frame rate, analyze an aspect of the first set of video frames in relation to an aspect of the second set of video frames, generate a mapped set of video frames based on the analyzing and a mapping of the aspect of the first set of video frames to the aspect of the second set of video frames, and store the mapped set of video frames on a display of the device.

Some examples of the method, apparatuses, and non-transitory computer-readable medium described herein may further include operations, features, means, or instructions for determining a first motion difference between a first frame of the first set of video frames and a first frame of the second set of video frames.

Some examples of the method, apparatuses, and non-transitory computer-readable medium described herein may further include operations, features, means, or instructions for determining a second motion difference between the first frame of the first set of video frames and a second frame of the second set of video frames, where the aspect of the first set of video frames or the aspect of the second set of video frames, or both, include the first motion difference and the second motion difference.

Some examples of the method, apparatuses, and non-transitory computer-readable medium described herein may further include operations, features, means, or instructions for generating a first frame of the mapped set of video frames based on overlaying the first motion difference on the first frame of the first set of video frames and generating a second frame of the mapped set of video frames based on overlaying the second motion difference on the first frame of the first set of video frames.

Some examples of the method, apparatuses, and non-transitory computer-readable medium described herein may further include operations, features, means, or instructions for determining color information or luma information, or both, of a pixel of the first frame of the first set of video frames and applying the color information or the luma information, or both, to a corresponding pixel of the first frame of the mapped set of video frames.

Some examples of the method, apparatuses, and non-transitory computer-readable medium described herein may further include operations, features, means, or instructions for determining a common feature between the first frame of the first set of video frames and the first frame of the second set of video frames and using the common feature from the first frame of the first set of video frames in a first frame of the mapped set of video frames.

Some examples of the method, apparatuses, and non-transitory computer-readable medium described herein may further include operations, features, means, or instructions for determining a difference between a field of view of the first sensor and a field of view of the second sensor and cropping the first frame of the first set of video frames or the first frame of the second set of video frames, or both, based on the determined difference between the field of view of the first sensor and the field of view of the second sensor.

In some examples of the method, apparatuses, and non-transitory computer-readable medium described herein, the aspect of the first set of video frames includes lighting information, or brightness information, or color information, or luma information, or any combination thereof.

In some examples of the method, apparatuses, and non-transitory computer-readable medium described herein, the aspect of the second set of video frames includes motion information.

In some examples of the method, apparatuses, and non-transitory computer-readable medium described herein, two or more frames of the second set of video frames correspond to one frame of the first set of video frames based on the second frame rate being different from the first frame rate.

### BRIEF DESCRIPTION OF THE DRAWINGS

FIG. 1 illustrates an example of an image processing system that supports techniques for enhancing slow motion recording in accordance with aspects of the present disclosure.

FIG. 2 illustrates an example of a frame capture system that supports techniques for enhancing slow motion recording in accordance with aspects of the present disclosure.

FIG. 3 illustrates an example of a frame capture environment that supports techniques for enhancing slow motion recording in accordance with aspects of the present disclosure.

FIGS. 4 and 5 show block diagrams of devices that support increasing the quality of slow motion video in accordance with aspects of the present disclosure.

FIG. 6 shows a block diagram of a multimedia manager that supports techniques for enhancing slow motion recording in accordance with aspects of the present disclosure.

FIG. 7 shows a diagram of a system including a device that supports techniques for enhancing slow motion recording in accordance with aspects of the present disclosure.

FIGS. 8 and 9 show flowcharts illustrating methods that support increasing the quality of slow motion video in accordance with aspects of the present disclosure.

### DETAILED DESCRIPTION

The present techniques include increasing the quality of slow motion video. Slow motion video may be captured at relatively high frame rates (e.g., 60 frames per second (fps), 120 fps, 240 fps, 480 fps, 960 fps, etc.). Capturing slow motion video in indoor lighting, fluorescent lighting, or relatively low light scenes results in decreased video quality compared to some video frame rates (e.g., 24 fps or 30 fps video). The amount of detail in a given frame is based on the amount of light that reaches an image sensor, and the amount of light reaching the image sensor for a given frame is based on the exposure time per frame. To ensure the high frame rate output for slow motion video, the exposure time of each captured frame is increasingly shortened as the frame rate increases. As the time between consecutive frames decreases, the exposure time available for each video frame decreases. Thus, the shorter the exposure time, the less detailed and more grainy or noisy the captured frames become.

The present techniques may include using two cameras or two image sensors on one device to simultaneously capture two sets of video frames. The techniques may include analyzing the two sets of video frames and mapping aspects of the analyzed sets of video frames to generate an enhanced set of video frames. In some examples, the two sets of video frames may be captured at different frame rates. The different frame rates may include a set of anchor frames (e.g., a first set of video frames) captured at a relatively low frame rate (e.g., 24 fps or 30 fps) to capture lighting details of the scene (e.g., lighting information, brightness information, color information, luma information, etc.). The different frame rates may also include a set of motion frames (e.g., a second set of video frames) captured at a relatively high frame rate (e.g., 60 fps, 120 fps, 240 fps, 480 fps, 960 fps, etc.) to capture slow motion aspects of the scene. The present techniques may include analyzing the set of motion frames in relation to the set of anchor frames, mapping aspects of the set of motion frames with aspects of the set of anchor frames based on the analysis, and generating a mapped set of frames based on the mapping.

Aspects of the subject matter described herein may be implemented to realize increased quality of slow motion video. The described techniques provide the image-based motion information of slow motion video combined with the lighting details of 24 fps or 30 fps video. Additionally, described techniques are scalable on all devices that include at least two cameras, providing the same highest frame rate available on the cameras with increased lighting details, thus improving user experience.

Aspects of the disclosure are initially described in the context of a multimedia system. Aspects of the disclosure are further illustrated by and described with reference to frame capture systems and frame capture environments that relate to enhancing scene statistics for slow motion recording. Aspects of the disclosure are further illustrated by and described with reference to apparatus diagrams, system diagrams, and flowcharts that relate to enhancing scene statistics for slow motion recording.

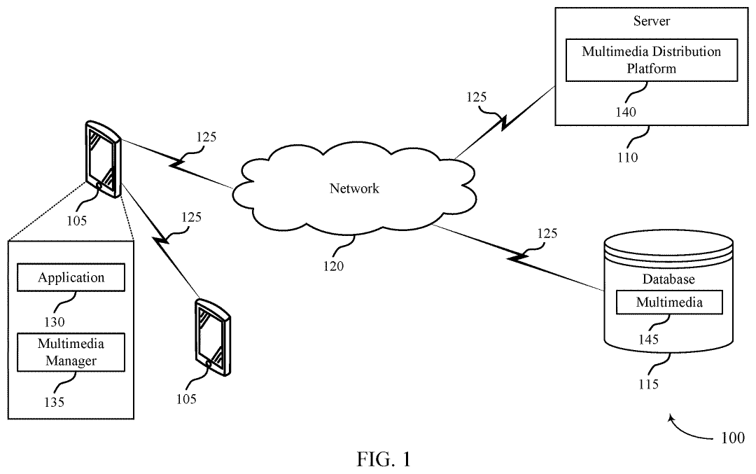

FIG. 1 illustrates a multimedia system 100 for a device that supports techniques for enhancing slow motion recording in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports enhancing scene statistics for slow motion recording, such as multimedia packets, multimedia data, or multimedia control information, via network 120 using communications links 125. In some cases, a portion or all of the techniques described herein supporting enhancing scene statistics for slow motion recording may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support enhancing scene statistics for slow motion recording, according to the techniques described herein.

The server 110 may be a data server, a cloud server, a server associated with an multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support enhancing scene statistics for slow motion recording associated with the multimedia 145. The device 105 may retrieve the stored data from the database 115 via the network 120 using communications links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The communications links 125 may transmit bidirectional communications and/or unidirectional communications. In some examples, the communications links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some examples, device 105 may provide increased quality of slow motion video captured by device 105. In some cases, device 105 may provide the image-based motion information of slow motion video combined with the lighting details of 24 fps or 30 fps video. Additionally, the operations of device 105 may be scalable on any device that includes at least two cameras, providing slow motion video based on the highest frame rate available on a given camera while providing increased lighting details compared to slow motion video captured using a single camera, thus improving user experience.

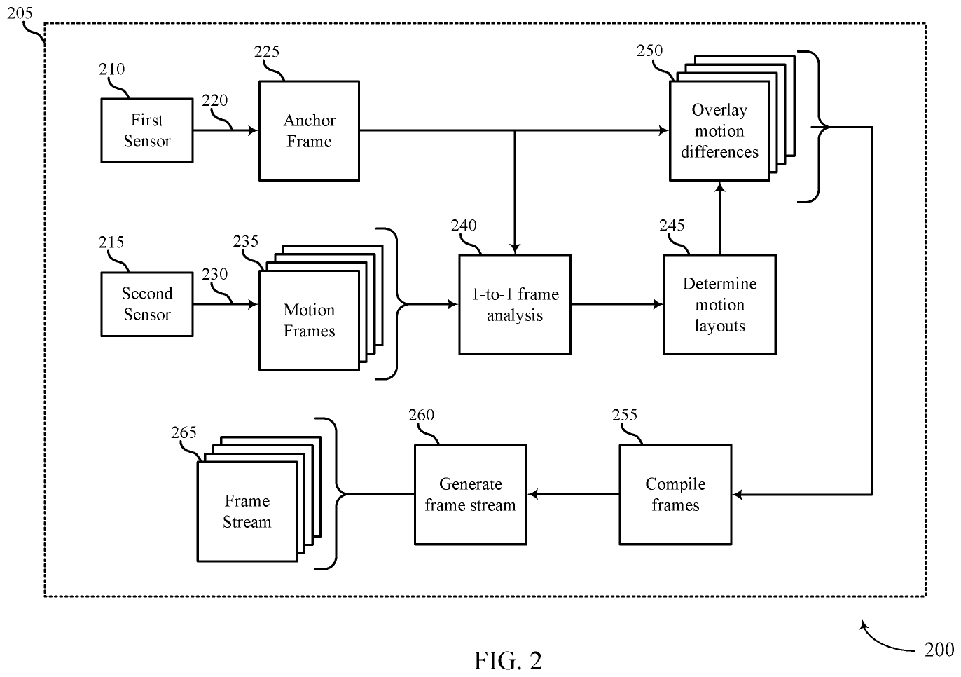

FIG. 2 illustrates an example of a frame capture system 200 that supports techniques for enhancing slow motion recording in accordance with aspects of the present disclosure.

In the illustrated example, frame capture system 200 may include device 205, which may be an example of a device 105 of FIG. 1. In some examples, device 205 may include one or more image sensors (e.g., one or more cameras). In some cases, the one or more image sensors may include first sensor 210 or second sensor 215, or both.

In some examples, first sensor 210 may generate a first video stream that includes anchor frame 225, and second sensor 215 may generate a second video stream that includes motion frames 235. In some cases, first sensor 210 may capture one or more video frames at a first frame rate 220 (e.g., 24 fps, 30 fps), while second sensor 215 may capture one or more video frames at second frame rate 230 (e.g., 60 fps, 120 fps, 240 fps, 480 fps, 960 fps, etc.) that is different than the first frame rate.

In some examples, frame capture system 200 depicts video image frames simultaneously captured by first sensor 210 and second sensor 215 within a given time period based on the first frame rate 220 and the second frame rate 230. In some cases, the first frame rate 220 may be set at 30 fps, the second frame rate 230 may be set at 120 fps, and the given time period may be 0.33 seconds. The frame rate 220 set at 30 fps results in 1 frame being captured every 0.033 seconds, while the frame rate 230 set at 120 fps results in 1 frame being captured every 0.00833 seconds. Thus, during a time period of 0.033 seconds, first sensor 210 may capture a single anchor frame 225, while second sensor 215 may capture four motion frames 235. With an exposure time at or relatively near 0.033 seconds for anchor frame 225 and an exposure time at or relatively near 0.00833 seconds for each of the four frames of motion frames 235, anchor frame 225 may capture more lighting details than each frame of motion frames 235 within the same time period of 0.033 seconds. Similarly, with an exposure time at or relatively near 0.033 seconds for anchor frame 225 and an exposure time at or relatively near 0.00833 seconds for each of the four frames of motion frames 235, motion frames 235 may capture more motion information (e.g., movement of objects within the scene captured in each of the four motion frames 235) than anchor frame 225 within the same time period of 0.033 seconds.

At 240, device 205 may analyze anchor frame 225 in relation to motion frames 235. In some cases, device 205 may analyze anchor frame 225 in relation to a first frame of motion frames 235, analyze anchor frame 225 in relation to a second motion of motion frames 235, and so on. In some cases, device 205 may analyze a first frame of motion frames 235 in relation to a second frame of motion frames 235, and so on. In some cases, the analyzing may include device 205 comparing a first frame to a second frame (e.g., comparing anchor frame 225 to a first frame of motion frames 235, comparing to a second frame of motion frames 235, comparing a first frame of motion frames 235 to a second frame of motion frames 235, and so on).

In some examples, device 205 may identify one or more aspects regarding anchor frame 225 and motion frames 235 based on the analysis. In some cases, identifying the one or more aspects may include identifying motion information in motion frames 235 relative to anchor frame 225. Identifying the motion information may include identifying portions (e.g., pixel locations) of anchor frame 225 or motion frames 235, or both, where movement occurs. In some cases, identifying the one or more aspects may include identifying a difference between lighting details in the anchor frame 225 and lighting details in one or more frames of the motion frames 235. In some cases, the lighting details may include luma information (e.g., pixel luma values), or color information (e.g., pixel color values), or any combination thereof, of the respective frames. In some cases, identifying the one or more aspects may include identifying areas that are common (e.g., static) to at least one frame of motion frames 235 and anchor frame 225, or identifying objects that are common to at least one frame of motion frames 235 and anchor frame 225, or identifying a movement of an identified object in at least one frame of motion frames 235 relative to anchor frame 225 or relative to another frame of motion frames 235, or identifying a static portion that is common to anchor frame 225 and at least one frame of motion frames 235, or identifying variations in a field of view of anchor frame 225 and a field of view of at least one frame of motion frames 235, or any combination thereof.

At 245, device 205 may determine motion layouts for each frame of motion frames 235 based on the one-to-one frame analysis performed at 240. In some cases, the motion layouts may include a layout (e.g., location, coordinates, pixel locations) of motion in a given frame based on where device 105 determines the motion occurs. In some cases, determining motion layouts may include identifying portions of motion frames 235 where motion occurs relative to anchor frame 225. In some cases, detecting portions of motion frames 235 where movement occurs may include identifying an object in anchor frame 225 and identifying the same object in at least one frame of motion frames 235. In some cases, detecting portions of motion frames 235 where movement occurs may include determining a movement of the object. In some cases, determining the movement of the object may include determining a first position of the object in anchor frame 225 and a second position of the object in a given frame of motion frames 235 when anchor frame 225 occurs before the given frame of motion frames 235, or determining a first position of the object in a given frame of motion frames 235 and a second position of the object in anchor frame 225 when anchor frame 225 occurs after the given frame of motion frames 235. In some cases, determining the movement of the object may include determining a first position of the object in a first frame of motion frames 235 and a second position of the object in a second frame of motion frames 235 when the first frame of motion frames 235 occurs before the second frame of motion frames 235. Accordingly, device 205 may identify motion differences (e.g., determined motion, determined movement of objects, etc.) between the respective frames and generate motion layouts based on the identified motion differences.

In some examples, device 205 may pass one or more motion differences through a correction filter. Based on the longer exposure time of anchor frame 225, anchor frame 225 may have more lighting details and higher quality compared to motion frames 235. Accordingly, common portions (e.g., static portions) of anchor frame 225 and motion frames 235 may be selected from anchor frame 225 when generating a new enhanced frame (e.g., a mapped frame) from anchor frame 225 and motion frames 235. In some cases, a motion difference (e.g., motion portion) of the mapped frame may be selected from motion frames 235. However, due to the lower lighting detail and lower quality (e.g., higher noise) of motion frames 235, device 205 may pass one or more motion differences through a correction filter to give a more uniform quality between the common portions and motion portions of the mapped frame.

At 250, device 205 may overly the motion differences on instances of the anchor frame 225. In some cases, device 205 may determine a first set of one or more motion differences between a first frame of motion frames 235 and anchor frame 225, or a second set of one or more motion differences between a second frame of motion frames 235 and anchor frame 225, or a third set of one or more motion differences between a third frame of motion frames 235 and anchor frame 225, or a fourth set of one or more motion differences between a fourth frame of motion frames 235 and anchor frame 225, or any combination thereof. In some cases, device 205 may overly the first set of one or more motion differences on a first instance of anchor frame 225 to generate a first mapped frame, or overlay the second set of one or more motion differences on a second instance of anchor frame 225 to generate a second mapped frame, or overlay the third set of one or more motion differences on a third instance of anchor frame 225 to generate a third mapped frame, or overlay the fourth set of one or more motion differences on a fourth instance of anchor frame 225 to generate a fourth mapped frame, or any combination thereof. In some cases, a first set of mapped frames may include the four mapped frames based on anchor frame 225 and motion frames 235, and a second set of mapped frames may include another four mapped frames based on another anchor frame and another set of motion frames that correspond to the other anchor frame.

In some examples, overlaying a set of one or more motion differences on an instance of anchor frame 225 may include mapping a location of a determined movement (e.g., a set of one or more motion pixels) of a frame of motion frames 235 to a corresponding location of anchor frame 225 and laying the determined movement (e.g., the set of one or more motion pixels) over the corresponding location (e.g., corresponding pixels) of the instance anchor frame 225 to generate a mapped frame.

At 255, device 205 may compile all of the sets of mapped frames (e.g., first set of mapped frames, second set of mapped frames, etc.) into a compiled set of mapped frames. In some cases, each anchor frame (e.g., anchor frame 225) and each motion frame (e.g., motion frames 235) may include a timestamp that indicates when a given frame is captured. In some cases, an anchor frame or motion frame may include a timing offset (e.g., anchor frame captured at t0, first motion frame captured at a first timing offset relative to t0, second motion frame captured at a second timing offset relative to t0, etc.).

In some cases, device 205 may determine, based on the respective timestamps, whether anchor frame 225 occurs before, at the same time, or after a given frame of motion frames 235. In some cases, device 205 may compile the sets of mapped frames into the compiled set of mapped frames based on the respective timestamps.

At 260, device 205 may generate a frame stream 265 (e.g., final frame stream) from the compiled set of mapped frames. In some cases, generating the frame stream 265 may include formatting the compiled set of mapped frames into a slow motion video. In some cases, generating the frame stream 265 may include applying video algorithm to the compiled set of mapped frames. In some cases, generating the frame stream 265 may include encoding the compiled set of mapped frames or applying a video codec to the compiled set of mapped frames. In some cases, device 205 may display one or more frames of frame stream 265 on a display of device 205.

The present techniques may increase a quality of slow motion video captured by device 205. In some examples, device 205 may provide increased quality of slow motion video captured by merging aspects of a first video stream (e.g. a set of anchor frames including anchor frame 225) with aspects of a second video stream (e.g., a set of motion frames including motion frames 235). In some cases, device 205 may provide the image-based motion information of slow motion video (e.g., motion frames 235) combined with the lighting details of 24 fps or 30 fps video (e.g., anchor frame 225). Additionally, the operations of device 205 may be scalable on any device that includes at least two cameras, providing the same highest frame rate available on a given camera of the device while providing increased lighting details when compared to slow motion video captured with a single camera, thus improving user experience.

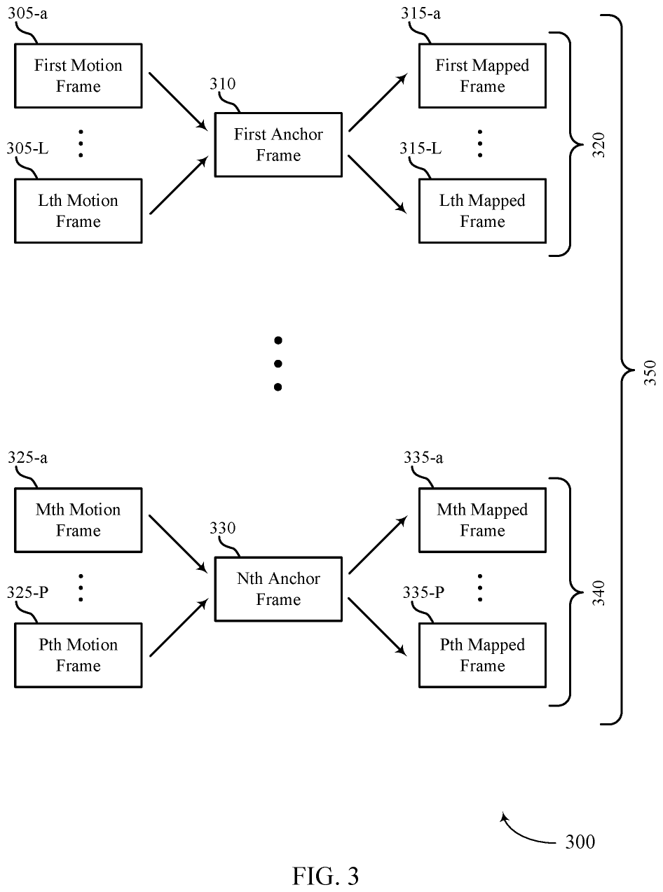

FIG. 3 illustrates an example of a frame capture environment 300 that supports techniques for enhancing slow motion recording in accordance with aspects of the present disclosure.

In some examples, frame capture environment 300 may include frame stream 350 that includes P total frames, where P is a positive integer. Frame stream 350 may include N frame sets that include first frame set 320 to Nth frame set 340, where N is a positive integer.

In the illustrated example, frame stream 350 may include N anchor frames and P motion frames that are captured by a corresponding device (e.g., device 105, device 205, etc.) over N time periods. In some cases, the corresponding device may capture first frame set 320 within a first time period and capture Nth frame set 340 within an Nth time period. The first frame set 320 may include first anchor frame 310 and L motion frames (e.g., first motion frame 305-a to Lth motion frame 305-L), where L is a positive integer. The Nth frame set 340 may include Nth anchor frame 330 as well as L motion frames (e.g., Mth motion frame 325-a to Pth motion frame 325-P), where M is a positive integer. In some cases, each frame set of frame stream 350 may include L motion frames (e.g., one anchor frame for each set of L motion frames).

In some examples, L may be based on the frame rate at which motion frames are captured. In some cases, L may be described in relation to the anchor frame rate (e.g., frame rate used to capture anchor frames such as first anchor frame 310). The anchor frame rate may be 30 fps (e.g., 30 fps or less). If the configured motion frame rate is 60 fps (e.g., twice the 30 fps anchor frame rate), then L is 2, or two motion frames for each anchor frame; if the configured motion frame rate is 120 fps (e.g., four times the anchor 30 fps frame rate), then L is 4, or four motion frames for each anchor frame; if the configured motion frame rate is 240 (e.g., eight times the 30 fps anchor frame rate), then L is 8, or eight motion frames for each anchor frame, and so on. The configured motion frame rate may vary from 60 fps to at least 960 fps.

In some examples, N may represent the number of anchor frames that are captured within the N time periods (e.g., N anchor frames of frame stream 350). In some cases, M may represent the first motion frame of Nth frame set 340 (e.g., Mth motion frame 325-a), where M=(N−1)*L+1. In some cases, P may represent the total number of motion frames that are captured in frame stream 350, and the last motion frame captured in the Nth frame set 340. Thus, when L is 4 (e.g., four motion frames for each anchor frame) and N is 3 (e.g., 3 anchor frames captured within 3 time periods), then M=(3−1)*4+1=9 (e.g., 9^{th} motion frame), and P=3*4=12 (e.g., 12^{th} motion frame).

In some examples, the corresponding device may determine scene differences between each motion frame and a corresponding anchor frame, and overlaying the differences on the anchor frame to generate a new frame set. In some cases, a single anchor frame (e.g., first anchor frame 310) may be analyzed in relation to the multiple motion frames that correspond to that single anchor frame (e.g., first motion frame 305-a to Lth motion frame 305-L). For every set of corresponding frames (e.g., four 120 fps motion frames for every one 30 fps anchor frame), the analysis may include determining scene differences between each motion frame of a set of motion frames and a single anchor frame corresponding to the set of motion frames. In some cases, the present techniques may include overlaying the determined scene differences for each motion frame in the set of motion frames onto the anchor frame to generate a new frame set. In some cases, the corresponding device may overlay the determined scene differences of first motion frame 305-a onto first anchor frame 310 to generate first mapped frame 315-a, and overlay the determined scene differences of Lth motion frame 305-L onto first anchor frame 310 to generate Lth mapped frame 315-L, resulting in a first set of L mapped frames for first frame set 320. In some cases, the corresponding device may overlay the determined scene differences of Mth motion frame 325-a onto Nth anchor frame 330 to generate Mth mapped frame 335-a, and overlay the determined scene differences of Pth motion frame 325-P onto Nth anchor frame 330 to generate Pth mapped frame 335-P, resulting in an Nth set of L mapped frames for Nth frame set 340.

In some cases, determining motion differences between an anchor frame and a motion frame may include identifying an object in the anchor frame and identifying the same object in the motion frame, and determining a shift in the location of the identified object in the motion frame compared to the location of the identified object in the anchor frame. In some cases, overlaying the motion difference on the anchor frame may include shifting the identified object in the anchor frame to match the location of the object in the motion frame. In some cases, overlaying the motion difference on the anchor frame may include overlaying pixels of the identified object in the motion frame onto corresponding pixels of the anchor frame, resulting in a modified anchor frame (e.g., a mapped video frame) where the location of the object in the modified anchor frame matches the location of the object in the motion frame. In some cases, overlaying the motion difference on the anchor frame may include digitally shifting the pixels of the identified object in the anchor frame resulting in a modified anchor frame, where the location of the object in the modified anchor frame matches the location of the object in the motion frame.

In some examples, the corresponding device may use lighting details (e.g., brightness information, or color information, or luma information, or any combination thereof) from a respective anchor frame (e.g., instead of lighting detail from a corresponding motion frame) to generate a new frame (e.g., using lighting details from the anchor frame to generate a first new frame, using lighting details from the anchor frame to generate a second new frame, etc.). In some cases, the corresponding device may use lighting details of first anchor frame 310 to generate one or more portions of first mapped frame 315-a, and use lighting details of first anchor frame 310 to generate one or more portions of Lth mapped frame 315-L. In some cases, the corresponding device may use lighting details of Nth anchor frame 330 to generate one or more portions of Mth mapped frame 335-a, and use lighting details of Nth anchor frame 330 to generate one or more portions of Pth mapped frame 335-P.

Accordingly, a set of motion frames corresponding to an anchor frame may provide motion information that is missing from the anchor frame, while the anchor frame may provide lighting detail that is missing from the set of motion frames, and merging the motion information from the motion frames with the lighting detail from the anchor frame and generating, based on the merging, a new set of frames results in slow motion video frames with increased lighting details and higher quality (e.g., lower noise) compared to other slow motion videos. Thus, the present techniques may increase the detail and quality of slow motion videos captured by a device configured with the present techniques. In some examples, the corresponding device may provide increased quality of slow motion video captured by merging aspects of a first video stream (e.g. N anchor frames) with aspects of a second video stream (e.g., P total motion frames with sets of L motion frames corresponding to each respective anchor frame). In some cases, the corresponding device may provide the image-based motion information of slow motion video (e.g., P motion frames) combined with the lighting details of 24 fps or 30 fps video (e.g., N anchor frames). Additionally, the operations of the corresponding device may be scalable to any device that includes at least two cameras, providing the same highest frame rate available on a given camera of the device while providing increased lighting details when compared to slow motion video captured with a single camera, thus improving user experience.

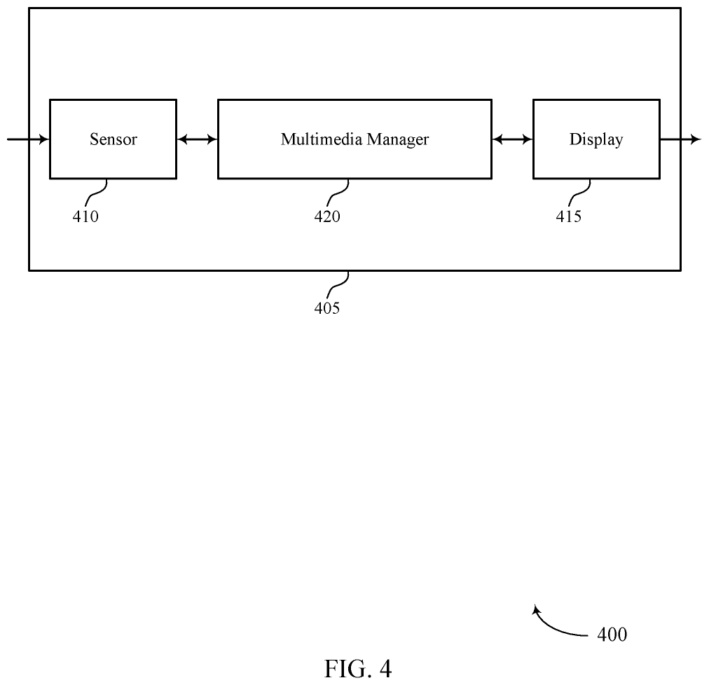

FIG. 4 shows a block diagram 400 of a device 405 that supports techniques for enhancing slow motion recording in accordance with aspects of the present disclosure. The device 405 may be an example of aspects of a Camera Device as described herein. The device 405 may include a sensor 410, a display 415, and a multimedia manager 420. The device 405 may also include a processor. Each of these components may be in communication with one another (e.g., via one or more buses).

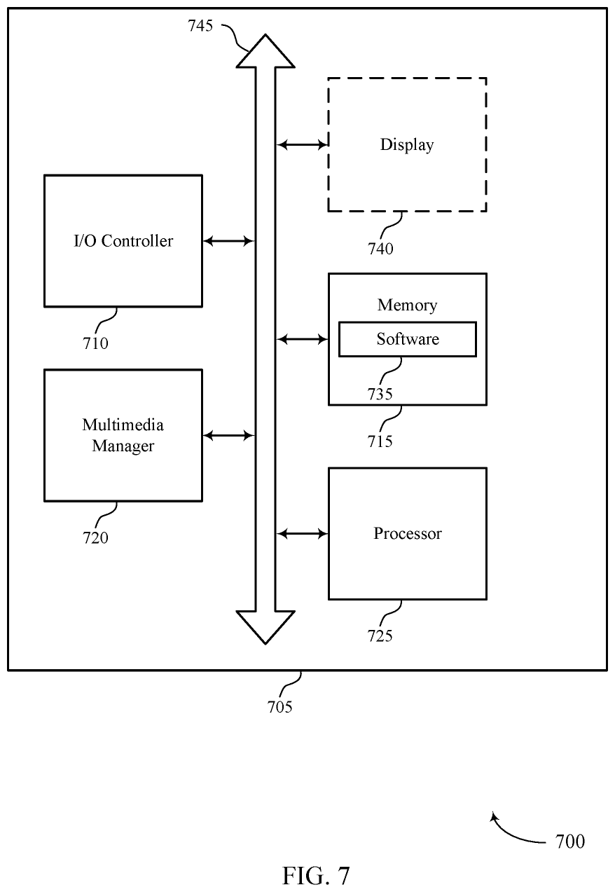

The one or more sensors 410 (e.g., image sensors, cameras, etc.) may receive information (e.g., light, for example, visible light and/or invisible light), which may be passed on to other components of the device 405. In some cases, the sensors 410 may be an example of aspects of the I/O controller 710 described with reference to FIG. 7. A sensor 410 may utilize one or more photosensitive elements that have a sensitivity to a spectrum of electromagnetic radiation to receive information (e.g., a sensor 410 may be configured or tuned to receive a pixel intensity value, red green blue (RGB) values, infrared (IR) light values, near-IR light values, ultraviolet (UV) light values of a pixel, etc.). The information may then be passed on to other components of the device 405.

Display 415 may display content generated by other components of the device. Display 415 may be an example of display 740 as described with reference to FIG. 7. In some examples, display 740 may be connected with a display buffer which stores rendered data until an image is ready to be displayed (e.g., as described with reference to FIG. 7). The display 415 may illuminate according to signals or information generated by other components of the device 405. For example, the display 415 may receive display information (e.g., pixel mappings, display adjustments) from sensor 410, and may illuminate accordingly. The display 415 may represent a unit capable of displaying video, images, text or any other type of data for consumption by a viewer. Display 415 may include a liquid-crystal display (LCD), a light emitting diode (LED) display, an organic LED (OLED), an active-matrix OLED (AMOLED), or the like. In some cases, display 415 and an I/O controller (e.g., I/O controller 710) may be or represent aspects of a same component (e.g., a touchscreen) of device 405. The display 415 may be any suitable display or screen allowing for user interaction and/or allowing for presentation of information (such as captured images and video) for viewing by a user. In some aspects, the display 415 may be a touch-sensitive display. In some cases, the display 415 may display images captured by sensors, where the displayed images that are captured by sensors may depend on the configuration of light sources and active sensors by the multimedia manager 420.

The multimedia manager 420, the sensor 410, the display 415, or various combinations thereof or various components thereof may be examples of means for performing various aspects of enhancing scene statistics for slow motion recording as described herein. For example, the multimedia manager 420, the sensor 410, the display 415, or various combinations or components thereof may support a method for performing one or more of the functions described herein.

In some examples, the multimedia manager 420, the sensor 410, the display 415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the multimedia manager 420, the sensor 410, the display 415, or various combinations or components thereof may be implemented in code (e.g., as communications management software or firmware) executed by a processor. If implemented in code executed by a processor, the functions of the multimedia manager 420, the sensor 410, the display 415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the multimedia manager 420 may be configured to perform various operations (e.g., receiving, monitoring, transmitting) using or otherwise in cooperation with the sensor 410, the display 415, or both. For example, the multimedia manager 420 may receive information from the sensor 410, send information to the display 415, or be integrated in combination with the sensor 410, the display 415, or both to receive information, transmit information, or perform various other operations as described herein.

The multimedia manager 420 may support image processing at a device in accordance with examples as disclosed herein. For example, the multimedia manager 420 may be configured as or otherwise support a means for capturing from a first sensor of the device a first set of video frames at a first frame rate. The multimedia manager 420 may be configured as or otherwise support a means for capturing from a second sensor of the device a second set of video frames at a second frame rate different from the first frame rate. The multimedia manager 420 may be configured as or otherwise support a means for analyzing an aspect of the first set of video frames in relation to an aspect of the second set of video frames. The multimedia manager 420 may be configured as or otherwise support a means for generating a mapped set of video frames based on the analyzing and a mapping of the aspect of the first set of video frames to the aspect of the second set of video frames. The multimedia manager 420 may be configured as or otherwise support a means for storing the mapped set of video frames on a display of the device.

By including or configuring the multimedia manager 420 in accordance with examples as described herein, the device 405 (e.g., a processor controlling or otherwise coupled to the sensor 410, the display 415, the multimedia manager 420, or a combination thereof) may support techniques for increasing a quality of slow motion video captured by device 405. In some examples, device 405 may provide increased quality of slow motion video captured by merging aspects of a first video stream (e.g. a set of anchor frames) with aspects of a second video stream (e.g., a set of motion frames). In some cases, device 405 may provide the image-based motion information of slow motion video (e.g., motion frames) combined with the lighting details of 24 fps or 30 fps video (e.g., anchor frame). Additionally, the operations of device 405 may be scalable on any device that includes at least two cameras, providing the same highest frame rate available on a given camera of the device while providing increased lighting details when compared to slow motion video captured with a single camera, thus improving user experience.

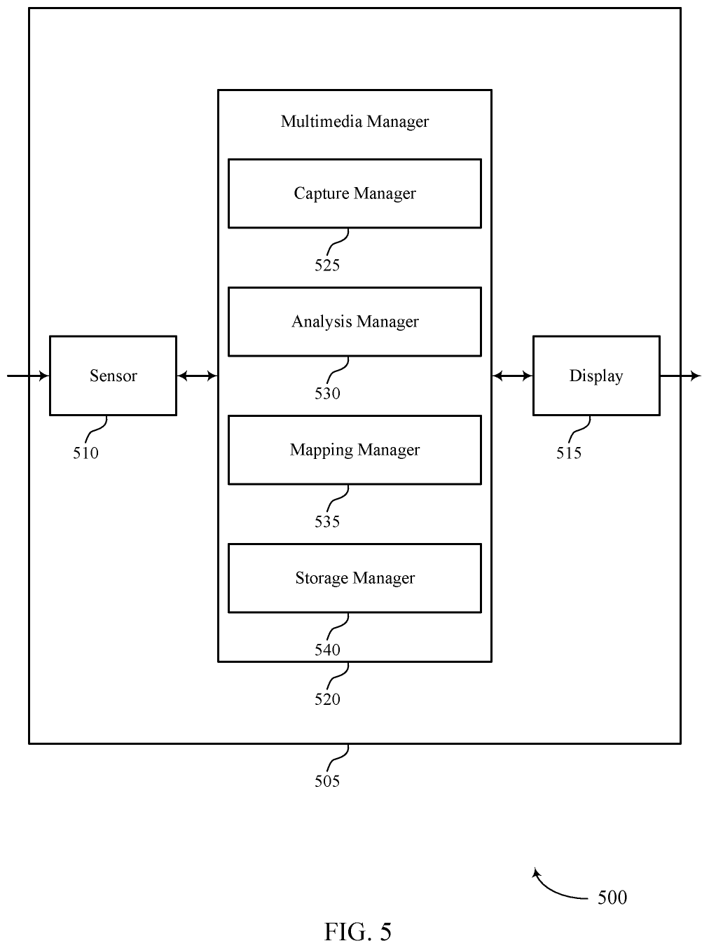

FIG. 5 shows a block diagram 500 of a device 505 that supports techniques for enhancing slow motion recording in accordance with aspects of the present disclosure. The device 505 may be an example of aspects of a device 405 as described herein. The device 505 may include a sensor 510, a display 515, and a multimedia manager 520. The device 505 may also include a processor. Each of these components may be in communication with one another (e.g., via one or more buses).

The one or more sensors 510 (e.g., image sensors, cameras, etc.) may receive information (e.g., light, for example, visible light and/or invisible light), which may be passed on to other components of the device 505. In some cases, the sensors 510 may be an example of aspects of the I/O controller 710 described with reference to FIG. 7. A sensor 510 may utilize one or more photosensitive elements that have a sensitivity to a spectrum of electromagnetic radiation to receive information (e.g., a sensor 510 may be configured or tuned to receive a pixel intensity value, red green blue (RGB) values, infrared (IR) light values, near-IR light values, ultraviolet (UV) light values of a pixel, etc.). The information may then be passed on to other components of the device 505.

Display 515 may display content generated by other components of the device. Display 515 may be an example of display 740 as described with reference to FIG. 7. In some examples, display 740 may be connected with a display buffer which stores rendered data until an image is ready to be displayed (e.g., as described with reference to FIG. 7). The display 515 may illuminate according to signals or information generated by other components of the device 505. For example, the display 515 may receive display information (e.g., pixel mappings, display adjustments) from sensor 510, and may illuminate accordingly. The display 515 may represent a unit capable of displaying video, images, text or any other type of data for consumption by a viewer. Display 515 may include a liquid-crystal display (LCD), a light emitting diode (LED) display, an organic LED (OLED), an active-matrix OLED (AMOLED), or the like. In some cases, display 515 and an I/O controller (e.g., I/O controller 710) may be or represent aspects of a same component (e.g., a touchscreen) of device 505. The display 515 may be any suitable display or screen allowing for user interaction and/or allowing for presentation of information (such as captured images and video) for viewing by a user. In some aspects, the display 515 may be a touch-sensitive display. In some cases, the display 515 may display images captured by sensors, where the displayed images that are captured by sensors may depend on the configuration of light sources and active sensors by the multimedia manager 520.

The device 505, or various components thereof, may be an example of means for performing various aspects of enhancing scene statistics for slow motion recording as described herein. For example, the multimedia manager 520 may include a capture manager 525, an analysis manager 530, a mapping manager 535, a storage manager 540, or any combination thereof. The multimedia manager 520 may be an example of aspects of a multimedia manager 420 as described herein. In some examples, the multimedia manager 520, or various components thereof, may be configured to perform various operations (e.g., receiving, monitoring, transmitting) using or otherwise in cooperation with the sensor 510, the display 515, or both. For example, the multimedia manager 520 may receive information from the sensor 510, send information to the display 515, or be integrated in combination with the sensor 510, the display 515, or both to receive information, transmit information, or perform various other operations as described herein.

The multimedia manager 520 may support image processing at a device in accordance with examples as disclosed herein. The capture manager 525 may be configured as or otherwise support a means for capturing from a first sensor of the device a first set of video frames at a first frame rate. The capture manager 525 may be configured as or otherwise support a means for capturing from a second sensor of the device a second set of video frames at a second frame rate different from the first frame rate. The analysis manager 530 may be configured as or otherwise support a means for analyzing an aspect of the first set of video frames in relation to an aspect of the second set of video frames. The mapping manager 535 may be configured as or otherwise support a means for generating a mapped set of video frames based on the analyzing and a mapping of the aspect of the first set of video frames to the aspect of the second set of video frames. The storage manager 540 may be configured as or otherwise support a means for storing the mapped set of video frames on a display of the device.

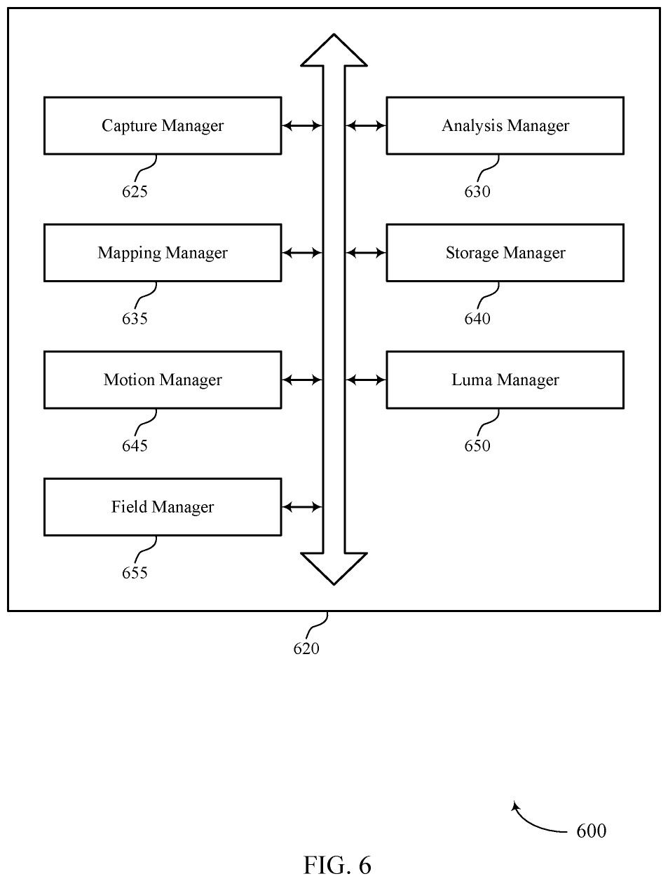

FIG. 6 shows a block diagram 600 of a multimedia manager 620 that supports techniques for enhancing slow motion recording in accordance with aspects of the present disclosure. The multimedia manager 620 may be an example of aspects of a multimedia manager 420, a multimedia manager 520, or both, as described herein. The multimedia manager 620, or various components thereof, may be an example of means for performing various aspects of enhancing scene statistics for slow motion recording as described herein. For example, the multimedia manager 620 may include a capture manager 625, an analysis manager 630, a mapping manager 635, a storage manager 640, a motion manager 645, a luma manager 650, a field manager 655, or any combination thereof. Each of these components may communicate, directly or indirectly, with one another (e.g., via one or more buses).

The multimedia manager 620 may support image processing at a device in accordance with examples as disclosed herein. The capture manager 625 may be configured as or otherwise support a means for capturing from a first sensor of the device a first set of video frames at a first frame rate. In some examples, the capture manager 625 may be configured as or otherwise support a means for capturing from a second sensor of the device a second set of video frames at a second frame rate different from the first frame rate. The analysis manager 630 may be configured as or otherwise support a means for analyzing an aspect of the first set of video frames in relation to an aspect of the second set of video frames. The mapping manager 635 may be configured as or otherwise support a means for generating a mapped set of video frames based on the analyzing and a mapping of the aspect of the first set of video frames to the aspect of the second set of video frames. The storage manager 640 may be configured as or otherwise support a means for storing the mapped set of video frames on a display of the device.

In some examples, the motion manager 645 may be configured as or otherwise support a means for determining a first motion difference between a first frame of the first set of video frames and a first frame of the second set of video frames.

In some examples, the motion manager 645 may be configured as or otherwise support a means for determining a second motion difference between the first frame of the first set of video frames and a second frame of the second set of video frames, where the aspect of the first set of video frames or the aspect of the second set of video frames, or both, include the first motion difference and the second motion difference.

In some examples, the motion manager 645 may be configured as or otherwise support a means for generating a first frame of the mapped set of video frames based on overlaying the first motion difference on the first frame of the first set of video frames. In some examples, the motion manager 645 may be configured as or otherwise support a means for generating a second frame of the mapped set of video frames based on overlaying the second motion difference on the first frame of the first set of video frames.

In some examples, the luma manager 650 may be configured as or otherwise support a means for determining color information or luma information, or both, of a pixel of the first frame of the first set of video frames. In some examples, the luma manager 650 may be configured as or otherwise support a means for applying the color information or the luma information, or both, to a corresponding pixel of the first frame of the mapped set of video frames.

In some examples, the mapping manager 635 may be configured as or otherwise support a means for determining a common feature between the first frame of the first set of video frames and the first frame of the second set of video frames. In some examples, the mapping manager 635 may be configured as or otherwise support a means for using the common feature from the first frame of the first set of video frames in a first frame of the mapped set of video frames.

In some examples, the field manager 655 may be configured as or otherwise support a means for determining a difference between a field of view of the first sensor and a field of view of the second sensor. In some examples, the field manager 655 may be configured as or otherwise support a means for cropping the first frame of the first set of video frames or the first frame of the second set of video frames, or both, based on the determined difference between the field of view of the first sensor and the field of view of the second sensor.

In some examples, the aspect of the first set of video frames includes lighting information, or brightness information, or color information, or luma information, or any combination thereof. In some examples, the aspect of the second set of video frames includes motion information. In some examples, two or more frames of the second set of video frames correspond to one frame of the first set of video frames based on the second frame rate being different from the first frame rate.

FIG. 7 shows a diagram of a system 700 including a device 705 that supports techniques for enhancing slow motion recording in accordance with aspects of the present disclosure. The device 705 may be an example of or include the components of a device 405, a device 505, or a Camera Device as described herein. The device 705 may include components for bi-directional voice and data communications including components for transmitting and receiving communications, such as a multimedia manager 720, an I/O controller 710, a memory 715, a processor 725, and a light source 730. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In some other cases, the I/O controller 710 may represent or interact with a modem, a keyboard, a mouse, a touchscreen, or a similar device. In some cases, the I/O controller 710 may be implemented as part of a processor, such as the processor 725. In some cases, a user may interact with the device 705 via the I/O controller 710 or via hardware components controlled by the I/O controller 710.

The memory 715 may include RAM and ROM. The memory 715 may store computer-readable, computer-executable code 735 including instructions that, when executed by the processor 725, cause the device 705 to perform various functions described herein. The code 735 may be stored in a non-transitory computer-readable medium such as system memory or other type of memory. In some cases, the code 735 may not be directly executable by the processor 725 but may cause a computer (e.g., when compiled and executed) to perform functions described herein. In some cases, the memory 715 may contain, among other things, a BIOS which may control basic hardware or software operation such as the interaction with peripheral components or devices.

The processor 725 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 725 may be configured to operate a memory array using a memory controller. In some other cases, a memory controller may be integrated into the processor 725. The processor 725 may be configured to execute computer-readable instructions stored in a memory (e.g., the memory 715) to cause the device 705 to perform various functions (e.g., functions or tasks supporting enhancing scene statistics for slow motion recording). For example, the device 705 or a component of the device 705 may include a processor 725 and memory 715 coupled to the processor 725, the processor 725 and memory 715 configured to perform various functions described herein.

The one or more light sources 730 may include light sources capable of emitting visible light and/or invisible light. In an example, the light sources 730 may include a visible light source and an active invisible light source (e.g., IR light source, near-IR light source, UV light source). In some cases, the light sources 730 may be an example of aspects of the light source 730 described with reference to FIG. 7.

The multimedia manager 720 may support image processing at a device in accordance with examples as disclosed herein. For example, the multimedia manager 720 may be configured as or otherwise support a means for capturing from a first sensor of the device a first set of video frames at a first frame rate. The multimedia manager 720 may be configured as or otherwise support a means for capturing from a second sensor of the device a second set of video frames at a second frame rate different from the first frame rate. The multimedia manager 720 may be configured as or otherwise support a means for analyzing an aspect of the first set of video frames in relation to an aspect of the second set of video frames. The multimedia manager 720 may be configured as or otherwise support a means for generating a mapped set of video frames based on the analyzing and a mapping of the aspect of the first set of video frames to the aspect of the second set of video frames. The multimedia manager 720 may be configured as or otherwise support a means for storing the mapped set of video frames on a display of the device.

By including or configuring the multimedia manager 720 in accordance with examples as described herein, the device 705 may support techniques for increasing a quality of slow motion video captured by device 705. In some examples, device 705 may provide increased quality of slow motion video captured by merging aspects of a first video stream (e.g. a set of anchor frames) with aspects of a second video stream (e.g., a set of motion frames). In some cases, device 705 may provide the image-based motion information of slow motion video (e.g., motion frames) combined with the lighting details of 24 fps or 30 fps video (e.g., anchor frame). Additionally, the operations of device 705 may be implemented on any device that includes at least two cameras, providing the same highest frame rate available on a given camera of the device while providing increased lighting details when compared to slow motion video captured with a single camera, thus improving user experience

The multimedia manager 720, or its sub-components, may be implemented in hardware, code (e.g., software or firmware) executed by a processor, or any combination thereof. If implemented in code executed by a processor, the functions of the multimedia manager 720, or its sub-components may be executed by a general-purpose processor, a DSP, an ASIC, a field programmable gate array (FPGA) or other programmable logic device, discrete gate or transistor logic, discrete hardware components, or any combination thereof designed to perform the functions described in the present disclosure. The multimedia manager 720, or its sub-components, may be physically located at various positions, including being distributed such that portions of functions are implemented at different physical locations by one or more physical components. In some examples, the multimedia manager 720, or its sub-components, may be a separate and distinct component in accordance with various aspects of the present disclosure. In some examples, the multimedia manager 720, or its sub-components, may be combined with one or more other hardware components, including but not limited to an I/O component, a camera controller, another computing device, one or more other components described in the present disclosure, or a combination thereof in accordance with various aspects of the present disclosure.

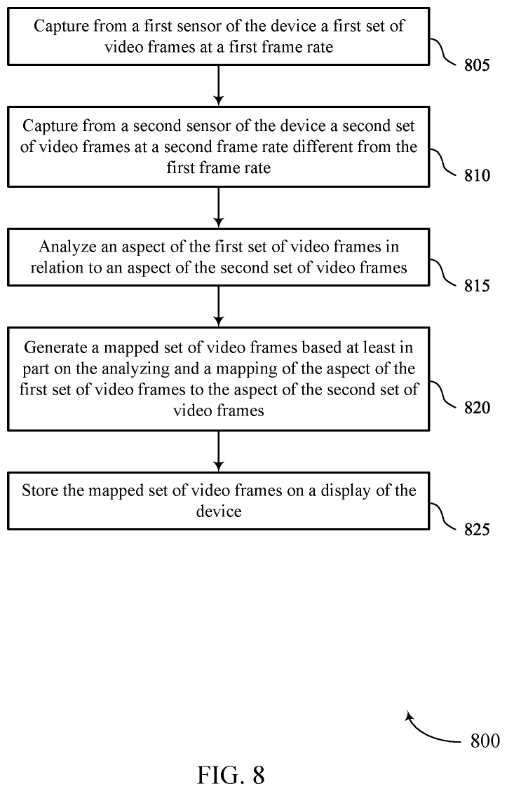

FIG. 8 shows a flowchart illustrating a method 800 that supports techniques for enhancing slow motion recording in accordance with aspects of the present disclosure. The operations of the method 800 may be implemented by a Camera Device or its components as described herein. For example, the operations of the method 800 may be performed by a Camera Device as described with reference to FIGS. 1 through 7. In some examples, a Camera Device may execute a set of instructions to control the functional elements of the Camera Device to perform the described functions. Additionally or alternatively, the Camera Device may perform aspects of the described functions using special-purpose hardware.

At 805, the method may include capturing from a first sensor of the device a first set of video frames at a first frame rate. The operations of 805 may be performed in accordance with examples as disclosed herein. In some examples, aspects of the operations of 805 may be performed by a capture manager 625 as described with reference to FIG. 6.

At 810, the method may include capturing from a second sensor of the device a second set of video frames at a second frame rate different from the first frame rate. The operations of 810 may be performed in accordance with examples as disclosed herein. In some examples, aspects of the operations of 810 may be performed by a capture manager 625 as described with reference to FIG. 6.

At 815, the method may include analyzing an aspect of the first set of video frames in relation to an aspect of the second set of video frames. The operations of 815 may be performed in accordance with examples as disclosed herein. In some examples, aspects of the operations of 815 may be performed by an analysis manager 630 as described with reference to FIG. 6.

At 820, the method may include generating a mapped set of video frames based on the analyzing and a mapping of the aspect of the first set of video frames to the aspect of the second set of video frames. The operations of 820 may be performed in accordance with examples as disclosed herein. In some examples, aspects of the operations of 820 may be performed by a mapping manager 635 as described with reference to FIG. 6.

At 825, the method may include storing the mapped set of video frames on a display of the device. The operations of 825 may be performed in accordance with examples as disclosed herein. In some examples, aspects of the operations of 825 may be performed by a storage manager 640 as described with reference to FIG. 6.

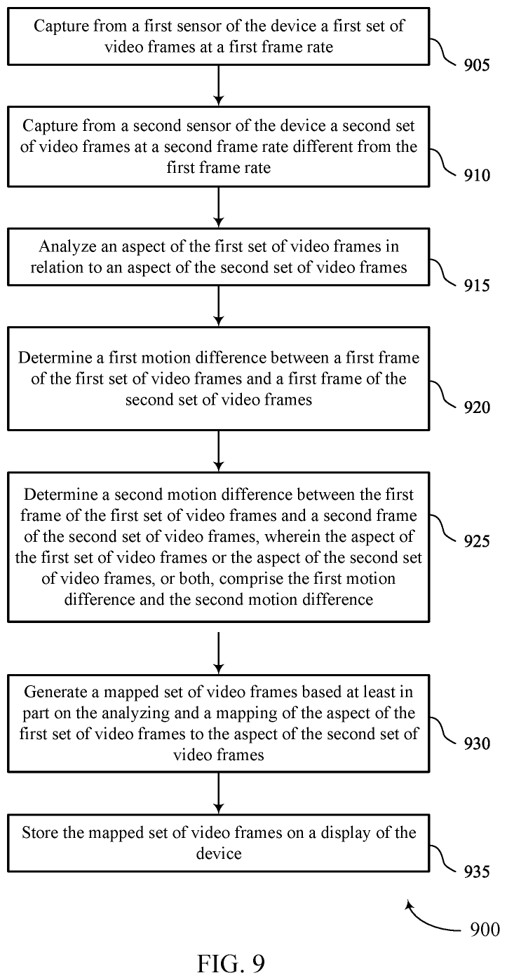

FIG. 9 shows a flowchart illustrating a method 900 that supports techniques for enhancing slow motion recording in accordance with aspects of the present disclosure. The operations of the method 900 may be implemented by a Camera Device or its components as described herein. For example, the operations of the method 900 may be performed by a Camera Device as described with reference to FIGS. 1 through 7. In some examples, a Camera Device may execute a set of instructions to control the functional elements of the Camera Device to perform the described functions. Additionally or alternatively, the Camera Device may perform aspects of the described functions using special-purpose hardware.

At 905, the method may include capturing from a first sensor of the device a first set of video frames at a first frame rate. The operations of 905 may be performed in accordance with examples as disclosed herein. In some examples, aspects of the operations of 905 may be performed by a capture manager 625 as described with reference to FIG. 6.

At 910, the method may include capturing from a second sensor of the device a second set of video frames at a second frame rate different from the first frame rate. The operations of 910 may be performed in accordance with examples as disclosed herein. In some examples, aspects of the operations of 910 may be performed by a capture manager 625 as described with reference to FIG. 6.

At 915, the method may include analyzing an aspect of the first set of video frames in relation to an aspect of the second set of video frames. The operations of 915 may be performed in accordance with examples as disclosed herein. In some examples, aspects of the operations of 915 may be performed by an analysis manager 630 as described with reference to FIG. 6.

At 920, the method may include determining a first motion difference between a first frame of the first set of video frames and a first frame of the second set of video frames. The operations of 920 may be performed in accordance with examples as disclosed herein. In some examples, aspects of the operations of 920 may be performed by a motion manager 645 as described with reference to FIG. 6.

At 925, the method may include determining a second motion difference between the first frame of the first set of video frames and a second frame of the second set of video frames, where the aspect of the first set of video frames or the aspect of the second set of video frames, or both, include the first motion difference and the second motion difference. The operations of 925 may be performed in accordance with examples as disclosed herein. In some examples, aspects of the operations of 925 may be performed by a motion manager 645 as described with reference to FIG. 6.

At 930, the method may include generating a mapped set of video frames based on the analyzing and a mapping of the aspect of the first set of video frames to the aspect of the second set of video frames. The operations of 930 may be performed in accordance with examples as disclosed herein. In some examples, aspects of the operations of 930 may be performed by a mapping manager 635 as described with reference to FIG. 6.

In some cases, the method may include generating a first frame of the mapped set of video frames based on overlaying the first motion difference on the first frame of the first set of video frames. In some cases, the method may include generating a second frame of the mapped set of video frames based on overlaying the second motion difference on the first frame of the first set of video frames.

At 935, the method may include storing the mapped set of video frames on a display of the device. The operations of 935 may be performed in accordance with examples as disclosed herein. In some examples, aspects of the operations of 935 may be performed by a storage manager 640 as described with reference to FIG. 6.

The following provides an overview of aspects of the present disclosure:

Aspect 1: A method for image processing at a device, comprising: capturing from a first sensor of the device a first set of video frames at a first frame rate; capturing from a second sensor of the device a second set of video frames at a second frame rate different from the first frame rate; analyzing an aspect of the first set of video frames in relation to an aspect of the second set of video frames; generating a mapped set of video frames based at least in part on the analyzing and a mapping of the aspect of the first set of video frames to the aspect of the second set of video frames; and storing the mapped set of video frames on a display of the device.

Aspect 2: The method of aspect 1, further comprising: determining a first motion difference between a first frame of the first set of video frames and a first frame of the second set of video frames.

Aspect 3: The method of aspect 2, further comprising: determining a second motion difference between the first frame of the first set of video frames and a second frame of the second set of video frames, wherein the aspect of the first set of video frames or the aspect of the second set of video frames, or both, comprise the first motion difference and the second motion difference.

Aspect 4: The method of aspect 3, further comprising: generating a first frame of the mapped set of video frames based at least in part on overlaying the first motion difference on the first frame of the first set of video frames; and generating a second frame of the mapped set of video frames based at least in part on overlaying the second motion difference on the first frame of the first set of video frames.

Aspect 5: The method of any of aspects 2 through 4, further comprising: determining color information or luma information, or both, of a pixel of the first frame of the first set of video frames; and applying the color information or the luma information, or both, to a corresponding pixel of the first frame of the mapped set of video frames.

Aspect 6: The method of any of aspects 2 through 5, further comprising: determining a common feature between the first frame of the first set of video frames and the first frame of the second set of video frames; and using the common feature from the first frame of the first set of video frames in a first frame of the mapped set of video frames.

Aspect 7: The method of any of aspects 2 through 6, further comprising: determining a difference between a field of view of the first sensor and a field of view of the second sensor; and cropping the first frame of the first set of video frames or the first frame of the second set of video frames, or both, based at least in part on the determined difference between the field of view of the first sensor and the field of view of the second sensor.

Aspect 8: The method of any of aspects 1 through 7, wherein the aspect of the first set of video frames comprises lighting information, or brightness information, or color information, or luma information, or any combination thereof.

Aspect 9: The method of any of aspects 1 through 8, wherein the aspect of the second set of video frames comprises motion information.

Aspect 10: The method of any of aspects 1 through 9, wherein two or more frames of the second set of video frames correspond to one frame of the first set of video frames based at least in part on the second frame rate being different from the first frame rate.

Aspect 11: An apparatus for image processing at a device, comprising a processor; memory coupled with the processor; and instructions stored in the memory and executable by the processor to cause the apparatus to perform a method of any of aspects 1 through 10.

Aspect 12: An apparatus for image processing at a device, comprising at least one means for performing a method of any of aspects 1 through 10.

Aspect 13: A non-transitory computer-readable medium storing code for image processing at a device, the code comprising instructions executable by a processor to perform a method of any of aspects 1 through 10.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
capturing from a first sensor of the device a first set of video frames at a first frame rate;
capturing from a second sensor of the device a second set of video frames at a second frame rate different from the first frame rate;
analyzing an aspect of the first set of video frames in relation to an aspect of the second set of video frames;
generating a mapped set of video frames based at least in part on the analyzing and a mapping of the aspect of the first set of video frames to the aspect of the second set of video frames; and
storing the mapped set of video frames on a display of the device.

2. The method of claim 1, further comprising:
determining a first motion difference between a first frame of the first set of video frames and a first frame of the second set of video frames.

3. The method of claim 2, further comprising:
determining a second motion difference between the first frame of the first set of video frames and a second frame of the second set of video frames, wherein the aspect of the first set of video frames or the aspect of the second set of video frames, or both, comprise the first motion difference and the second motion difference.

4. The method of claim 3, further comprising:
generating a first frame of the mapped set of video frames based at least in part on overlaying the first motion difference on the first frame of the first set of video frames; and
generating a second frame of the mapped set of video frames based at least in part on overlaying the second motion difference on the first frame of the first set of video frames.

5. The method of claim 2, further comprising:
determining color information or luma information, or both, of a pixel of the first frame of the first set of video frames; and
applying the color information or the luma information, or both, to a corresponding pixel of the first frame of the mapped set of video frames.

6. The method of claim 2, further comprising:
determining a common feature between the first frame of the first set of video frames and the first frame of the second set of video frames; and
using the common feature from the first frame of the first set of video frames in a first frame of the mapped set of video frames.

7. The method of claim 2, further comprising:
determining a difference between a field of view of the first sensor and a field of view of the second sensor; and
cropping the first frame of the first set of video frames or the first frame of the second set of video frames, or both, based at least in part on the determined difference between the field of view of the first sensor and the field of view of the second sensor.

8. The method of claim 1, wherein the aspect of the first set of video frames comprises lighting information, or brightness information, or color information, or luma information, or any combination thereof.

9. The method of claim 1, wherein the aspect of the second set of video frames comprises motion information.

10. The method of claim 1, wherein two or more frames of the second set of video frames correspond to one frame of the first set of video frames based at least in part on the second frame rate being different from the first frame rate.

11. An apparatus for image processing at a device, comprising:
a processor;
memory coupled with the processor; and
instructions stored in the memory and executable by the processor to cause the apparatus to:
capture from a first sensor of the device a first set of video frames at a first frame rate;
capture from a second sensor of the device a second set of video frames at a second frame rate different from the first frame rate;
analyze an aspect of the first set of video frames in relation to an aspect of the second set of video frames;
generate a mapped set of video frames based at least in part on the analyzing and a mapping of the aspect of the first set of video frames to the aspect of the second set of video frames; and
store the mapped set of video frames on a display of the device.

12. The apparatus of claim 11, wherein the instructions are further executable by the processor to cause the apparatus to:
determine a first motion difference between a first frame of the first set of video frames and a first frame of the second set of video frames.

13. The apparatus of claim 12, wherein the instructions are further executable by the processor to cause the apparatus to:
determine a second motion difference between the first frame of the first set of video frames and a second frame of the second set of video frames, wherein the aspect of the first set of video frames or the aspect of the second set of video frames, or both, comprise the first motion difference and the second motion difference.

14. The apparatus of claim 13, wherein the instructions are further executable by the processor to cause the apparatus to:
generate a first frame of the mapped set of video frames based at least in part on overlaying the first motion difference on the first frame of the first set of video frames; and
generate a second frame of the mapped set of video frames based at least in part on overlaying the second motion difference on the first frame of the first set of video frames.

15. The apparatus of claim 12, wherein the instructions are further executable by the processor to cause the apparatus to:
determine color information or luma information, or both, of a pixel of the first frame of the first set of video frames; and
apply the color information or the luma information, or both, to a corresponding pixel of the first frame of the mapped set of video frames.

16. The apparatus of claim 12, wherein the instructions are further executable by the processor to cause the apparatus to:
determine a common feature between the first frame of the first set of video frames and the first frame of the second set of video frames; and
used the common feature from the first frame of the first set of video frames in a first frame of the mapped set of video frames.

17. The apparatus of claim 12, wherein the instructions are further executable by the processor to cause the apparatus to:
determine a difference between a field of view of the first sensor and a field of view of the second sensor; and
crop the first frame of the first set of video frames or the first frame of the second set of video frames, or both, based at least in part on the determined difference between the field of view of the first sensor and the field of view of the second sensor.

18. The apparatus of claim 11, wherein the aspect of the first set of video frames comprises lighting information, or brightness information, or color information, or luma information, or any combination thereof.

19. An apparatus for image processing at a device, comprising:
means for capturing from a first sensor of the device a first set of video frames at a first frame rate;
means for capturing from a second sensor of the device a second set of video frames at a second frame rate different from the first frame rate;
means for analyzing an aspect of the first set of video frames in relation to an aspect of the second set of video frames;
means for generating a mapped set of video frames based at least in part on the analyzing and a mapping of the aspect of the first set of video frames to the aspect of the second set of video frames; and
means for storing the mapped set of video frames on a display of the device.

20. The apparatus of claim 19, further comprising:
means for determining a first motion difference between a first frame of the first set of video frames and a first frame of the second set of video frames.
